(19) United States
(12) Patent Application Publication
(10) Pub. No.: US 2014/0143039 A1
(43) Pub. Date: May 22, 2014

(54) SYSTEMS, METHODS AND MEDIA FOR DATA MINING OUT OF STOCK ITEMS

(71) Applicant: APPSENSE LIMITED, Warrington (GB)

(72) Inventor: Paul Keith BRANTON, Rochdale (GB)

(73) Assignee: APPSENSE, INC., Warrington (GB)

(21) Appl. No.: 13/683,888

(22) Filed: Nov. 21, 2012

(51) Int. Cl. G06Q 30/02

(52) U.S. Cl. CPC G06Q 30/0223
USPC 705/14.24

(57) ABSTRACT

Systems, methods and media are provided for data mining information related to an out of stock product. One method includes receiving at a server from a mobile node located in a retail store customer information of a customer and product information of a product that is not found in an area of the retail store that is designated for the product and determining whether the product is out of stock at the retail store by interrogating an inventory of the product stored in a database. The customer information includes customer identification (ID) information. The method also includes informing the customer of an offer to award a purchasing bonus if it is determined that the product is out of stock, wherein the purchasing bonus is redeemable at the retail store when a future purchasing of the product is made within a specified time limit.

### TECHNICAL FIELD

Disclosed systems, methods and media relate to data mining information related to out of stock items. Specifically, disclosed systems, methods and media relate to learning the shopping habits of retail customers based on out-of-stock items that the customers wanted but could not purchase.

### BACKGROUND

Many retailers use loyalty cards of one type or another to track the spending patterns of their customers and reward them for their patronages. Retailers can also keep track of stock inventory of items/products that they sell. For items sold online, retailers can record both the items that have been viewed and the items that have been placed on back orders. However, retailers currently do not have a way of determining if a customer wanted to buy an item sold at a retail store that was out of stock in the inventory. Data mining can be used to correlate usual shopping habits of retail customers and a retailer's stock level of inventories. However, the information learned from such method is only an extrapolation and thus may not be accurate or correct.

### SUMMARY

In accordance with the disclosed subject matter, systems, methods and media are provided for data mining information related to out of stock items. Specifically, disclosed systems, methods and media provide for data mining information related to out of stock items sold in retail stores using NFC-enabled or RFID-enabled loyalty cards of one type or another and/or customers' mobile devices, such as camera phones or smart phones. For example, the shelves where items are sold or item price tags on or near such shelves may be enabled using near field communication (NFC) readers or radio frequency identification (RFID) detectors such that retailers can learn whether a customer wanted but failed to purchase an out-of-stock item when the customer scans his or her NFC/RFID-enabled loyalty card on, e.g., an enabled shelf or enabled price tag, for the out of stock item.

The disclosed subject matter includes a method. The method can include receiving at a server from a mobile node located in a retail store customer information of a customer and product information of a product that is not found in an area of the retail store designated for the product. The customer information includes customer identification (ID) information. The method can further include determining at the server whether the product is out of stock at the retail store by interrogating an inventory of the product stored in a database and, if it is determined at the server that the product is out of stock, informing the customer of a time-limited offer to award a purchasing bonus. The purchasing bonus is redeemable at the retail store when a future purchasing of the product is made within a specified time limit

The disclosed subject matter also includes an apparatus for data mining information related to a product that is out of stock. The apparatus can include one or more interfaces configured to provide communication with at least one mobile node over a network. The apparatus can also include a processor, in communication with the one or more interfaces, configured to run a module stored in memory that is configured to receive from a mobile node located in a retail store customer information of a customer and product information of a product that is not found in an area of the retail store designated for the product. The customer information includes customer identification (ID) information. The module run by the processor is also configured to determine whether the product is out of stock at the retail store by interrogating an inventory of the product stored in a database. The module run by the processor is further configured to inform the customer of a time-limited offer to award a purchasing bonus, if it is determined that the product is out of stock. The purchasing bonus is redeemable at the retail store when a future purchasing of the product is made within a specified time limit.

The disclosed subject matter further includes a non-transitory computer readable medium. The computer readable medium can have executable instructions operable to cause an apparatus to receive from a mobile node located in a retail store customer information of a customer and product information of a product that is not found in an area of the retail store designated for the product. The customer information includes customer identification (ID) information and customer's location information. The mobile node includes a mobile device of the customer. The computer readable medium can further include executable instructions operable to cause the apparatus to determine whether the product is out of stock at the retail store by interrogating an inventory of the product stored in a database and, if it is determined that the product is out of stock, inform the customer of a time-limited offer to award a purchasing bonus. The purchasing bonus is redeemable at the retail store when a future purchasing of the product is made within a specified time limit.

The computer readable medium can further include executable instructions operable to cause the apparatus to determine whether the out of stock product is available at one of: a nearby branch of the retail store or a remote warehouse of the retail store and, if it is determined that at least one of the out of stock product is available at a remote warehouse of the retail store, to interact with the customer through the mobile node to send an offer of a home delivery of the product at a discounted rate and receive the customer's decision whether to accept the offer. If it is determined that at least one of the out of stock product is available at a nearby branch of the retail store, however, the executable instructions can further cause the apparatus to inform the customer of an availability of the out of stock product through the mobile node and send to the mobile node at least one of: an address of the nearby branch, a telephone number of the nearby branch, and a driving direction to the nearby branch via at least one of: an email, an instant text message or a telephone call.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with an embodiment of the disclosed subject matter.

FIG. 2 is a flow diagram for data mining information related to out of stock items using customer loyalty cards in accordance with certain embodiments of the disclosed subject matter.

FIG. 3 is a flow diagram for data mining information related to out of stock items using customers' mobile devices in accordance with certain embodiments of the disclosed subject matter.

FIG. 4 is a block diagram of a server device in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed subject matter relates to systems, methods and media for data mining information related to out of stock items sold at retail stores that the customers wanted to but could not purchase. Unlike the items sold online, it is difficult to ascertain whether customers wanted to purchase an item sold in a retail store but could not buy it because it happens to be out of stock. Information related to such out of stock items, if it can be mined and recorded, can help retailers better understand the shopping habits of their customers. The disclosed systems, methods and media provide ways in which both retailers and their customers can benefit from out-of-stock events, where customers wanted but could not purchase out of stock items.

In some embodiments, for example, customers are provided with a loyalty card including electronically stored customer identification (ID) information. The customer ID information can be scanned on a scan-enabled shelf (or a price tag) having, e.g., an embedded near field communication (NFC) reader or a radio frequency identification (RFID) detector. When a customer visits a retail store and discovers that an item that she wishes to purchase is missing from a scan-enabled shelf, for instance, the customer can scan her loyalty card on the scan-enabled shelf to inform the retailer that she wanted to but could not purchase the item. The retailer's device (e.g., a server coupled to the scan-enabled shelf) records and time-stamps the event and stores the ID information of the customer and the missing item. The retailer's device later determines whether the item is actually out of stock (as opposed to not being available on shelf) and, if the item is determined to be out of stock, offers the customer a time-limited discount for future purchasing of the out of stock item. When the item is restocked, the retailer (e.g., the retailer's server) notifies the customer that the item is restocked and available for sale at the retail store. If the customer visits the retail store again and purchases the item within the specified time limit, the offered discount is applied to the purchase, thereby confirming that the customer really wanted but could not purchase the item earlier (as opposed to, e.g., simply wanting to view the item).

In another embodiment, customers are enabled to inform a retailer of an out of stock event using their mobile devices. When a customer visits a retail store and discovers that an item that she wants to purchase is not on display, for example, the customer can capture (e.g., scan or take a picture of) the barcode of the item and send the barcode along with the customer's ID and location information to the retailer's device, such as a server. In response, the server can check (in real time) whether the item is actually out of stock and, if it is determined that the item is out of stock, whether the retailer's warehouse or a nearby branch store has the item in stock. If the item is out of stock, the customer is offered a time limited discount (or an award of additional bonus points in her account with the retailer) for a future purchase of the item. If the item is in stock in the retailer's warehouse, the customer may be also offered a free or discounted home delivery of the item. The customer may then choose to accept the home delivery offer or wait until the item is restocked to take advantage of the discount offer. The customer is notified when the item is restocked in the retail store. If the customer visits the retail store again and purchases the item within the specified time limit, the offered discount, or award of additional bonus points, is honored.

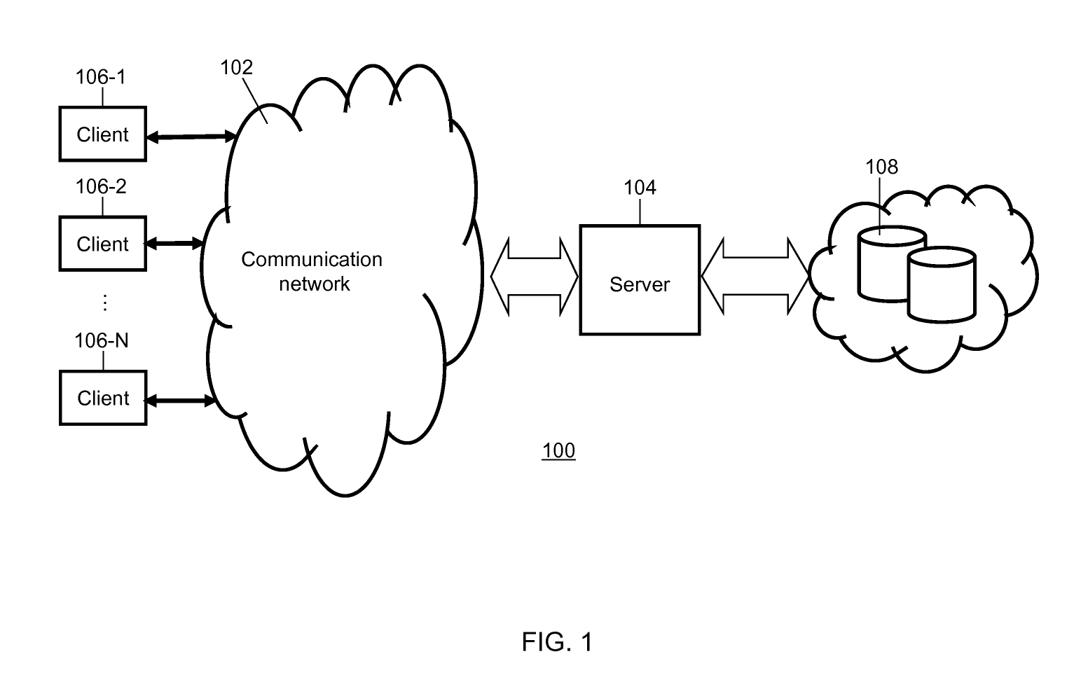

FIG. 1 illustrates a diagram of a networked communication arrangement in accordance with an embodiment of the disclosed subject matter. The networked communication arrangement 100 can include a communication network 102, a server 104, at least one client 106 (e.g., clients 106-1, 106-2, . . . 106-N), and a database 108.

Each client 106 can send data to, and receive data from, the server 104 over the communication network 102. Each client 106 can be directly coupled to the server 104; alternatively, each client 106 can be connected to server 104 via any other suitable device(s), communication network(s), or combination thereof. For example, each client 106 can be coupled to the server 104 via one or more routers, switches, access points, and/or communication networks (as described below in connection with communication network 102).

A client 106 can include a desktop computer, a mobile computer, a tablet computer, a cellular device, a smartphone or any computing system that is capable of performing computation. A client 106 can also include a near field communication (NFC) reader or a radio frequency identification (RFID) detector; alternatively, it could be a device that collects data from a network of NFC readers and/or RFID detectors. For example, a client 106 can be an NFC reader installed on a retail shelf that the customers of a retail store can use to indicate that the retail shelf designated for a particular item no longer has the items (not-on-shelf event), e.g., by scanning/swiping the loyalty cards that the retail store issues to the customers. The client 106 can also be a smartphone of a retail customer running one or more software applications that can interact with a retailer's server to report a not-on-shelf event.

The server 104 can be a single server, or a network of servers, or a farm of servers in a data center. For example, the server 104 may be a server located in a retail store, e.g., for receiving and processing information related to, e.g., missing retail items, that is transmitted from NFC readers/RFID detectors located in the retail store. The server 104 may also receive and process information related to retail items that is transmitted from customers' smartphones. For instance, the server 104 may run one or more processes that can interact with software applications running on the customers' smartphones to receive and process information related to retail items.

The communication network 102 can include a network or combination of networks that can accommodate private data communication. For example, the communication network 102 can include a local area network (LAN), a virtual private network (VPN) coupled to the LAN, a private cellular network, a private telephone network, a private computer network, a private packet switching network, a private line switching network, a private wide area network (WAN), a corporate network, or any number of private networks that can be referred to as an Intranet. Such networks may be implemented with any number of hardware and software components, transmission media and network protocols. FIG. 1 shows the network 102 as a single network; however, the network 102 can include multiple interconnected networks listed above. For instance, a network of NFC readers and/or RFID detectors and one or more servers located in an outlet of a retail chain may form a part of a local area network, and such local servers in each chain store may be connected to form a private WAN for the retail chain.

The server 104 can be coupled to a database system. The database 108 can include at least one of two types of database: a local database and a remotely located database. The database 108 can include any data supported by one or more of data structures; alternatively, it could include one or more database management system (DBMS) or a distributed database. For example, the database 108 may include a data structure, or one or more data tables in a DBMS, for storing information related to retail customers, such as customer ID, home/office addresses, telephone number(s), email address(es), purchase history, accrued loyalty points, etc. The database 108 can also include at least one of a relational database, object database (a.k.a., object-oriented database), XML database, cloud database, active database, and a data warehouse. The database 108 may include at least one physical, non-transitory storage medium.

In some embodiments, the database 108 can be provided as an enterprise system in a corporate environment For example, the communication network 102, the (proxy) server 104, the clients 106, and the database 108 can be located in a close proximity and can be a part of a single company. In some cases, the (proxy) server 104, the clients 106, and the database 108 can be located in the same building and can be coupled to one another via a local communication network. The local communication network can include a local area network (LAN), a corporate network, and a virtual private network (VPN) associated with the corporate network. FIG. 1 shows the database 108 as separate from the communication network 102. However, the database 108 can be part of communication network 102 or another communication network.

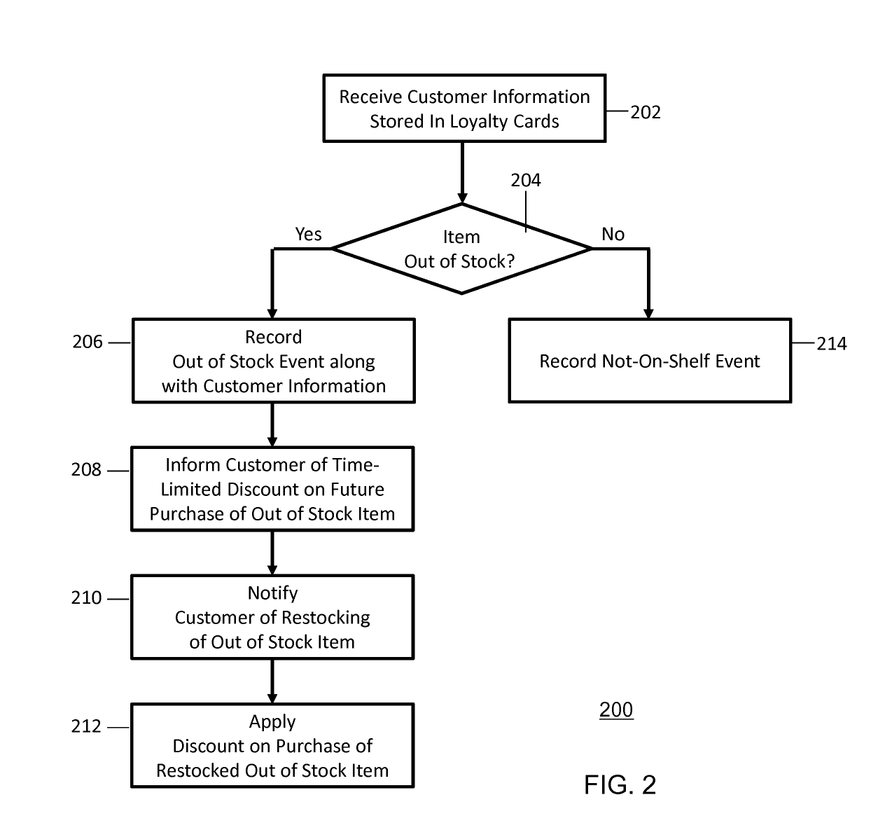

FIG. 2 is a flow diagram 200 for data mining information related to out of stock items using customer loyalty cards in accordance with certain embodiments of the disclosed subject matter. When a customer visits a retail store and finds that a desired item is no longer available on the store shelf that is designated for the item, the customer scans her NFC-enabled (or RFID-enabled) loyalty card on an electronic reader located at the shelf to indicate that she wanted but could not purchase the item. In some embodiments, the store shelf is enabled using a near field communication (NFC) reader or a radio frequency identification (RFID) detector for the scanning of loyalty cards. In some embodiments, a price tag associated with the out of stock item is enabled using an NFC reader or an RFID detector. A loyalty card may include the customer identification (ID) and other relevant customer information (e.g., accrued loyalty points). When the customer scans her loyalty card, the scan-enabled shelf or item price tag sends the customer information and the identification information of the out of stock item to a server.

At 202, the customer information is received, e.g., at a server, from a card reader (e.g., an NFC reader) upon the customer's scanning of her loyalty card. In some embodiments, the customer information may include a customer identification (ID), her contact information (e.g., home address, work address, home phone number, mobile phone number, and/or an email address), the date the loyalty card was issued to the customer, accrued loyalty points, etc. In certain embodiments, however, the customer information may include only a customer ID and the rest of the customer information is stored in the retailer's database, e.g., for privacy and/or security reasons. In some embodiments, the ID of the missing item is stored in the card reader and transmitted along with the customer information. In some embodiment, only an ID of the card reader (e.g., card reader serial number) is transmitted along with the customer information and the server receiving the card reader ID obtains the ID of the missing item using the card reader ID.

At 204, it is determined whether the missing item is out of stock, e.g., by checking the inventory database of items that are sold at the retail store. For example, the missing item may be in stock but simply unavailable on shelf. If it is determined at 204 that the item is not out of stock but simply unavailable on shelf, the not-on-shelf event is recorded at 214. In some embodiments, a store clerk is alerted of the not-on-shelf event. For example, a store clerk may be paged to restock the not-on-shelf item.

If, however, it is determined at 204 that the item is indeed out of stock, the out of stock event is recorded at 206. For example, the out of stock event may be recorded along with the customer information. In some embodiments, the event is time-stamped to indicate the time when the loyalty card was scanned. At 208, the customer is informed of a time-limited offer of a discount, or an award of additional loyalty points, for future purchase of the out of stock item. For example, the customer may be informed of the time-limited offer via a telephone call, email, text message and/or a letter/coupon. The discount offer is time limited, e.g., to help ensure that the customer's scanning of her loyalty card was due to genuine disappointment and not a spurious attempt to receive a discount on an uncertain future purchase—i.e., a purchase that may or may not be realized.

In some embodiments, it can be further determined whether the customer has made an alternative purchase, i.e., a purchase of an item of alternative choice (e.g., a same or similar item with different brand names). If, for example, the customer purchases one or more items in the retail store after scanning her loyalty card for an out of stock item, the purchased items may be recorded and analyzed to determine whether any of the purchased items may qualify as an alternative to the out of stock item. For instance, if a customer scans for a breakfast cereal of one brand that is out of stock on the designated shelf and subsequently purchases a breakfast cereal of another brand, the subsequent purchase may be recorded as an alternative purchasing. In some embodiments, some items sold at a retail store may be selected and each selected item may be associated with a list of pre-selected items that qualify as alternatives to the item, e.g., to enable speedy determination whether an alternative purchasing was made.

At 210, the customer is notified when the out of stock item is restocked in the retail store. For example, the customer may be notified via one or more of: an email, a telephone call, an instant text message and a regular paper mail. In some embodiments, updating inventory database of the restocking of the item automatically triggers a notification to the customer that the out of stock item is restocked. At 212, the time-limited offer of a discount (or an award of additional loyalty points) is applied if the customer returns to the store for purchasing of the restocked item within the specified time limit. The customer's subsequent purchasing of the out of stock item can confirm to the retailer that the customer legitimately wanted the item. In some embodiments, the records of all transactions and notifications following the customer's scanning of her loyalty card for the out of stock item is stored in a same database that is used by an existing loyalty card scheme, e.g., in order to help ensure that the database is enhanced with the information on what the customer would have wanted to buy in addition to what the customer actually bought.

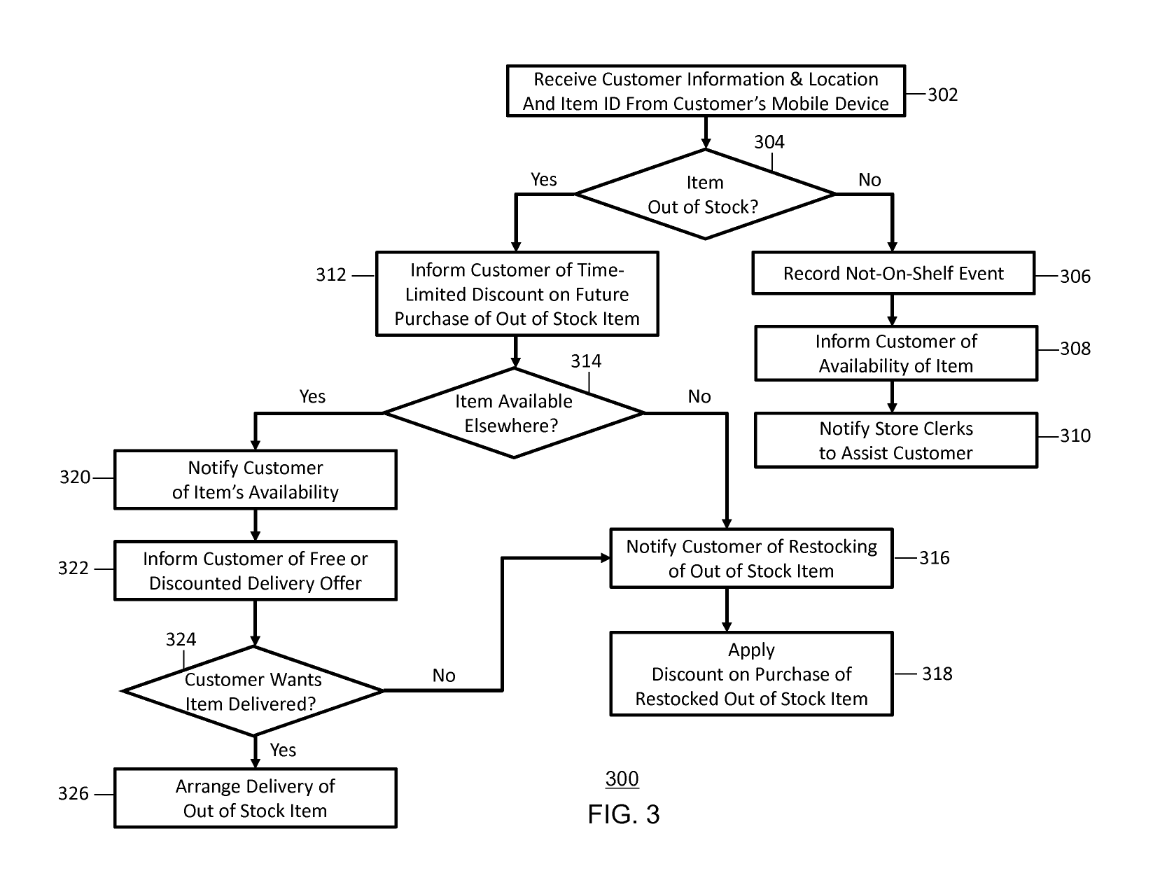

FIG. 3 is a flow diagram 300 for data mining information related to out of stock items using customers' mobile devices in accordance with certain embodiments of the disclosed subject matter. When a customer visits a retail store and finds that a desired item is no longer available on the store shelf designated for the item, the customer can use her mobile device, such as a smart-phone equipped with a digital camera, to capture (e.g., scan or take a picture of) the item's barcode that is displayed, e.g., on the designated shelf. In some embodiments, the customer's mobile device is loaded with a scanner application software that can read/scan a barcode captured by the digital camera included in the mobile device. In certain embodiments, the customer's mobile device includes an embedded barcode scanner.

In some embodiments, the customer's mobile device is loaded with an application software that can communicate and/or interact with the retailer's system or server. When the customer captures the barcode for the missing item, for instance, the application software running on the customer's mobile device can send to a server the customer's location along with other customer information and the information related to the missing item. In some embodiments, the application software running on the customer's mobile device interacts with the customer for the customer's confirmation before sending out the customer's location and other information.

At 302, the customer information and the information related to the missing item are received from the customer's mobile device, e.g., at the retailer's server. In some embodiments, a program running on the server interacts with the application software running on the customer's mobile device to receive the customer information and the information about the missing item. The customer information may include the customer's ID. The customer information may further include the customer's contact information and the loyalty points accrued for the customer.

At 304, it is determined whether the missing item is out of stock, e.g., by checking the inventory database of items that are sold at the retail store. For example, the item may be in stock but simply unavailable on shelf. If it is determined at 304 that the item is not out of stock but simply unavailable on shelf, the not-on-shelf event is recorded at 306 and the customer is notified in real-time at 308 that the item is simply unavailable on shelf and will be made available for sale shortly. For example, a telephone call can be made or an email or an instant text message can be sent to the customer's mobile device. At 310, a clerk of the retail store is notified in real-time of the not-on-shelf event so that the clerk can be dispatched to assist the customer. For example, the dispatched clerk can fetch the item from a local warehouse storage for the customer.

If, however, it is determined at 304 that the missing item is indeed out of stock, the out of stock event is recorded and at 312 the customer is informed of a time-limited offer of a discount, or an award of additional loyalty points, for future purchase of the out of stock item. For example, a telephone call can be made or an email or an instant text message can be sent to the customer's mobile device. The offer of a discount or an award of additional loyalty points is time-limited to help ensure that only genuine disappointments are accurately recorded and only genuinely disappointed customers receive discounts or additional loyalty points.

At 314, it is determined whether the out of stock item is available elsewhere, such as in a nearby branch or a warehouse storage of the retailer, e.g., by interrogating the inventory databases of nearby branches of the retailer. For example, the out of stock item may be available in the retailer's branch located in a neighboring town. If it is determined at 314 that the out of stock item is not available elsewhere (e.g., a nearby branch of the retailer), the retail store places an order for the out of stock item.

At 316, the customer is notified when the out of stock item is restocked in the retail store. For example, the customer may be notified via an email or an instant text message sent, or a telephone call made, to the customer's mobile device. In some embodiments, a notification message is received through the application software running on the customer's mobile device. At 318, the time-limited offer of a discount (or an award of additional loyalty points) is applied if the customer returns to the retail store and purchase the restocked item within the specified time limit. The customer's subsequent purchasing of the out of stock item can confirm to the retailer that the customer really wanted to purchase the item. In some embodiments, the records of all transactions and notifications following the receipt of the barcode of the out of stock item is stored in a same database that is used by an existing loyalty reward scheme.

If, however, it is determined at 314 that the out of stock item is available elsewhere, the customer is notified of the availability of the item at 320. If it is determined that the out of stock item is available at a nearby branch of the retailer, for example, the customer receives a notification as well as additional information, such as the address and telephone number of the nearby branch of the retailer and/or a driving direction to the nearby branch.

If the customer does not wish to travel to the nearby branch, or if the out of stock item is available only at the retailer's remote warehouse, the customer is informed at 322 that the out of stock item can be delivered to her home, office or an address of her designation either free of charge or at a discounted rate. At 324, the customer is asked whether she would like the out of stock item delivered to her. If the customer indicates at 324 that she wants the out of stock item delivered to her, e.g., free of charge (but without discount or additional loyalty points), a delivery of the out of stock item is arranged at 326.

If, however, the customer indicates at 324 that she would rather wait until the item is restocked (e.g., to take advantage of the offered discount or bonus loyalty points), the customer will be notified at 316 when the out of stock item is restocked. For example, the customer may be notified via one or more of: an email, a telephone call and an instant text message. If the customer purchases the restocked item within the specified time limit, the discount will be applied, or the bonus loyalty points will be awarded, at 318 when the purchase is made.

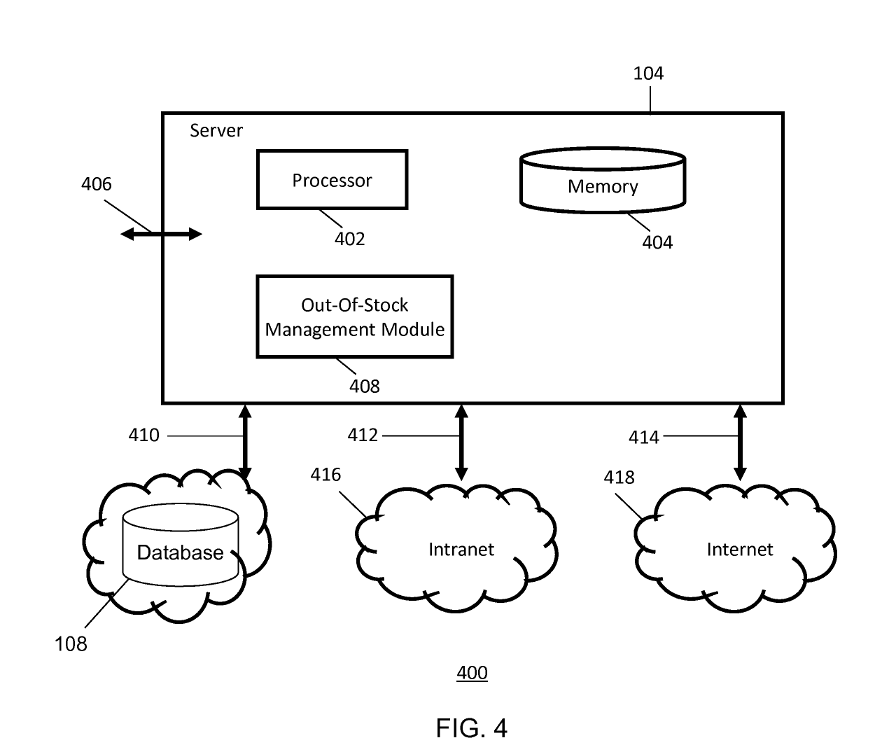

FIG. 4 is a block diagram 400 of a server device in accordance with certain embodiments of the disclosed subject matter. The block diagram 400 shows a server 104, which includes a processor 402, a memory 404, interfaces 406, 410, 412, and 414, an out-of-stock management module 408, a database 108, an Intranet 416, and the Internet 418. The memory 404 and the interfaces 406, 410, 412, and 414 are communicatively coupled to the processor 402. The server 104 can communicate with client devices 106 (not shown) via the interface 406; the server 104 can communicate with the database 108 via the interface 410; the server 104 can communicate with the Intranet 416 via the interface 412; and the server 104 can communicate with the Internet 418 via the interface 414. The interfaces 406, 410, 412, and 414 are shown as separate interfaces but may be the same physical interface. The processor 402 can run software programs and modules, including the out-of-stock management module 408. The memory 404 is capable of storing data that can be used by the processor 402 to run the software programs and modules.

The out-of-stock management (OOSM) module 408 can be configured to communicate, or interact, with one or more clients 106 through the interface 406 for data mining information related to out of stock items. For example, the OOSM module 408 can receive customer information (e.g., customer ID, customer location information) and information related to an item that are sent from a client 106, e.g., when the item is found to be missing from a designated shelf in a retail store. The OOSM module 408 can be also configured to determine whether the missing item is out of stock, e.g., by accessing the database 108 through the interface 410. For instance, the OOSM module 408 can check the inventory of the retail store that is maintained in the database 108 to determine whether the missing item is out of stock.

If the OOSM module 408 determines that the item is not out of stock (e.g., merely not available on the designated shelf), the OOSM module 408 can record the out-of-display event and store the information received from the client 106 in the database 108. In some embodiments, the OOSM module 408 can send a notification to the client 106, informing the client 106 of the availability of the missing item. If, however, the OOSM module 408 determines that the item is out of stock, the OOSM module 408 can send an offer of a time-limited discount for a future purchasing of the out of stock item. In some embodiments, a notification message regarding the time-limited offer is sent directly to the client 106. The OOSM module 408 can be further configured to send a notification when the inventory of the out of stock item in the database 108 is updated to reflect a restocking of the out of stock item. In some embodiments, the OOSM module 408 sends the notification directly to the client 106 via an email, an instant text message or a telephone call.

In some embodiments, the OOSM module 408 may be also configured to determine whether the item that is out of stock on the retail store is available elsewhere (e.g., a nearby branch or a warehouse of the retailer), e.g., by checking the inventories of the retailer that are maintained in the database 108. If the OOSM module 408 determines that a nearby branch of the retailer has in stock the out of stock item, the OOSM module 408 can, in some embodiments, send directly to the client 106 a notification message regarding the availability along with other information (e.g., address or telephone number of the nearby branch, driving direction to the nearby branch, etc.). If the OOSM module 408 determines that the retailer's remote warehouse has in stock the out of stock item, the OOSM module 408 can, in some embodiments, interact with the client 106 (e.g., a customer's smartphone) to determine whether the customer of the client 106 wants the item to be home delivered free of delivery charge or at a discounted delivery rate (but without any discount on the price of the item).

The out-of-stock management module 408 can be implemented in software using the memory 304. The memory 403 can be a non-transitory computer readable medium, flash memory, a magnetic disk drive, an optical drive, a programmable read-only memory (PROM), a read-only memory (ROM), or any other memory or combination of memories. The software can run on a processor 402 capable of executing computer instructions or computer code. The processor 402 might also be implemented in hardware using an application specific integrated circuit (ASIC), programmable logic array (PLA), field programmable gate array (FPGA), or any other integrated circuit.

FIG. 4 shows a server 104 having the out-of-stock module 408 that performs the above-described operations in accordance with certain embodiments of the disclosed subject matter. The server 104 may include additional modules, less modules, or any other suitable combination of modules that perform any suitable operation or combination of operations.

The interfaces 406, 410, 412, and 414 provide an input and/or output mechanism to communicate over a network. The interfaces 406, 410, 412, and 414 enable communication with clients, as well as other network nodes in the communication network 102. The interfaces 406, 410, 412, and 414 can be implemented in hardware to send and receive signals in a variety of mediums, such as optical, copper, and wireless, and in a number of different protocols some of which may be non-transient.

The server 104 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104. A task can be a software process that performs a specific function related to system control or session processing. Three types of tasks operate within the server 104 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 104 by monitoring the various software and hardware components of the server 104. Recovery control task subsystem is responsible for executing a recovery action for failures that occur in the server 104 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 104 with an ability to set, retrieve, and receive notification of server configuration parameter changes and is responsible for storing configuration data for the applications running within the server 104. A resource management subsystem is responsible for assigning resources (e.g., processor and memory capabilities) to tasks and for monitoring the task's use of the resources.

In some embodiments, the server 104 can reside in a data center and form a node in a cloud computing infrastructure. The server 104 can also provide services on demand. A module hosting a client is capable of migrating from one server to another server seamlessly, without causing program faults or system breakdown. The server 104 on the cloud can be managed using a management system.

The client 106 can include user equipment. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The client 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client 106 is configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The client 106 can also provide a variety of user interfaces such as a keyboard, a touch screen, a trackball, a touch pad, and/or a mouse. The client 106 may also include speakers and a display device in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for data mining information related to a product, the method comprising:
receiving at a server from a mobile node located in a retail store customer information of a customer and product information of a product that is not found in an area of the retail store designated for the product, wherein the customer information comprises customer identification (ID) information;
determining at the server whether the product is out of stock at the retail store by interrogating an inventory of the product stored in a database; and
if it is determined at the server that the product is out of stock, informing the customer of a time-limited offer to award a purchasing bonus, wherein the purchasing bonus is redeemable at the retail store when a future purchasing of the product is made within a specified time limit.

2. The method of claim 1,
wherein the designated area for the product in the retail store includes one of: a shelf designated for the product or an area where a price tag for the product can be found,
wherein the mobile node includes one of: a near field communication (NFC) reader or a radio frequency identification (RFID) detector, and
wherein the designated area is scan-enabled using the mobile node.

3. The method of claim 2, wherein the customer information and the product information are sent to the server when the customer scans a loyalty card when the product is not found on the designated area in the retail store, wherein the loyalty card stores the customer information and wherein the mobile node stores the product information.

4. The method of claim 1, wherein the mobile node includes a mobile device of the customer and the customer information further includes the customer's location information.

5. The method of claim 4, further comprising:
if it is determined at the server that the product is not out of stock at the retail store but simply not available on the designated area, informing in real time the customer of an availability of the product through the mobile node and alerting in real time an employee of the retail store to fetch the product to the customer from the retail store's local storage.

6. The method of claim 4, further comprising:
determining at the server whether the out of stock product is available at one of: a nearby branch of the retail store or a remote warehouse of the retail store;
if it is determined at the server that at least one of the out of stock product is available at a remote warehouse of the retail store, interacting with the customer through the mobile node to send an offer of a home delivery of the product at a discounted rate and receive the customer's decision whether to accept the offer; and
if it is determined at the server that at least one of the out of stock product is available at a nearby branch of the retail store, informing the customer of an availability of the out of stock product through the mobile node and sending to the mobile node at least one of: an address of the nearby branch, a telephone number of the nearby branch, and a driving direction to the nearby branch via at least one of: an email, an instant text message or a telephone call.

7. The method of claim 1, further comprising updating at the server the inventory of the product when the product is restocked at the retail store and notifying the customer of the restocking of the product at the retail store.

8. The method of claim 1, wherein the purchasing bonus includes one of: a discounted price of the product or an award of additional loyalty points.

9. An apparatus for data mining information related to a product, the apparatus comprising:
one or more interfaces configured to provide communication with at least one mobile node over a network; and
a processor, in communication with the one or more interfaces, configured to run a module stored in memory that is configured to:
receive from a mobile node located in a retail store customer information of a customer and product information of a product that is not found in an area of the retail store designated for the product, wherein the customer information comprises customer identification (ID) information;
determine whether the product is out of stock at the retail store by interrogating an inventory of the product stored in a database; and
if it is determined that the product is out of stock, inform the customer of a time-limited offer to award a purchasing bonus, wherein the purchasing bonus is redeemable at the retail store when a future purchasing of the product is made within a specified time limit.

10. The apparatus of claim 9,
wherein the designated area for the product in the retail store includes one of: a shelf designated for the product or an area where a price tag for the product can be found,
wherein the mobile node includes one of: a near field communication (NFC) reader or a radio frequency identification (RFID) detector, and
wherein the designated area is scan-enabled using the mobile node.

11. The apparatus of claim 9, wherein the customer information and the product information are received when the customer scans a loyalty card when the product is not found on the designated area in the retail store, wherein the loyalty card stores the customer information and wherein the mobile node stores the product information.

12. The apparatus of claim 9, wherein the mobile node includes a mobile device of the customer and the customer information further includes the customer's location information.

13. The apparatus of claim 12, the module run by the processor is further configured to inform in real time the customer of an availability of the product through the mobile node and alert in real time an employee of the retail store to fetch the product to the customer from the retail store's local storage, if it is determined that the product is not out of stock at the retail store but simply unavailable on the designated area.

14. The apparatus of claim 12, the module run by the processor is further configured to:
determine whether the out of stock product is available at one of: a nearby branch of the retail store or a remote warehouse of the retail store;
if it is determined that at least one of the out of stock product is available at a remote warehouse of the retail store, interact with the customer through the mobile node to send an offer of a home delivery of the product at a discounted rate and receive the customer's decision whether to accept the offer; and
if it is determined that at least one of the out of stock product is available at a nearby branch of the retail store, inform the customer of an availability of the out of stock product through the mobile node and send to the mobile node at least one of: an address of the nearby branch, a telephone number of the nearby branch, and a driving direction to the nearby branch via at least one of: an email, an instant text message or a telephone call.

15. The apparatus of claim 9, wherein the module run by the processor is further configured to update the inventory of the product when the product is restocked at the retail store and notify the customer of the restocking of the product at the retail store.

16. The apparatus of claim 9, wherein the purchasing bonus includes one of: a discounted price of the product or an award of additional loyalty points.

17. A non-transitory computer readable medium having executable instructions operable to cause an apparatus to:
receive from a mobile node located in a retail store customer information of a customer and product information of a product that is not found in an area of the retail store designated for the product, wherein the customer information comprises customer identification (ID) information and customer's location information and the mobile node includes a mobile device of the customer;
determine whether the product is out of stock at the retail store by interrogating an inventory of the product stored in a database; and
if it is determined that the product is out of stock,
inform the customer of a time-limited offer to award a purchasing bonus, wherein the purchasing bonus is redeemable at the retail store when a future purchasing of the product is made within a specified time limit;
determine whether the out of stock product is available at one of: a nearby branch of the retail store or a remote warehouse of the retail store;
if it is determined that at least one of the out of stock product is available at a remote warehouse of the retail store, interact with the customer through the mobile node to send an offer of a home delivery of the product at a discounted rate and receive the customer's decision whether to accept the offer; and
if it is determined that at least one of the out of stock product is available at a nearby branch of the retail store, inform the customer of an availability of the out of stock product through the mobile node and send to the mobile node at least one of: an address of the nearby branch, a telephone number of the nearby branch, and a driving direction to the nearby branch via at least one of: an email, an instant text message or a telephone call.

18. The computer readable medium of claim 17, wherein the executable instructions are further operable to cause the apparatus to inform in real time the customer of an availability of the product through the mobile node and alert in real time an employee of the retail store to fetch the product to the customer from the retail store's local storage, if it is determined that the product is not out of stock at the retail store but simply unavailable on the designated area.

19. The computer readable medium of claim 17, wherein the purchasing bonus includes a discounted price of the product.

20. The computer readable medium of claim 17, wherein the mobile device of the customer includes a smartphone that runs a scanner application software that can read a barcode of the product from a picture of the barcode that is taken using a digital camera included in the smartphone.
